(19) United States
(12) Patent Application Publication
(10) Pub. No.: US 2017/0323213 A1
(43) Pub. Date: Nov. 9, 2017

(54) Digital Marking Processing Apparatus

(71) Applicant: FACTORY AUTOMATION TECHNOLOGY CO., LTD., Chiayi County (TW)

(72) Inventors: PO CHENG SU, Chiayi County (TW); Hsin Hong Hou, Chiayi County (TW); Fan Tien Cheng, Chiayi County (TW); Haw Ching Yang, Chiayi County (TW); Hao Tieng, Chiayi County (TW)

(21) Appl. No.: 15/587,357

(22) Filed: May 4, 2017

(30) Foreign Application Priority Data
May 4, 2016 (TW) 105206398

(51) Int. Cl. G06N 5/04; G06K 1/12; G06N 5/02

(52) U.S. Cl. CPC G06N 5/046; G06N 5/022; G06K 1/121; G06K 2207/1012

(57) ABSTRACT

A digital marking processing apparatus includes a central control unit, and a processing quality prediction unit, a processing unit and a marking unit which are respectively connected with the central control unit electrically. The processing quality prediction unit can implement a virtual processing quality prediction method to predict the processing quality of the workpiece, output an accurate data of quality to the central control unit and generate tool path for the processing unit to process the workpiece. The central control unit is able to compile the data of quality from the processing quality in prediction unit into file information, so that the marking unit can then utilize the file information to correspondingly mark barcode or other digital pattern on the workpiece, which facilitate workpiece management and information disclosure.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a digital marking processing apparatus, and more particularly to a digital marking processing apparatus that marks related information with digital barcode on a workpiece during the processing.

### Description of Related Arts

In order to upgrade the efficiency and quality of workpiece processing, the industry utilizes numerical controlled digital processing apparatus to process the processing machine and applies relatively new workpiece processing quality prediction technology to expect that the workpiece processing quality can be timely and effectively managed during the processing. This workpiece processing quality prediction technology is disclosed in Taiwan Patent Number TWI481978B, entitled “Method for predicting machining quality of machine tool” (claiming priority of U.S. Patent Application No. 61/722,250). It can predict data of the quality of the processed workpiece during the processing of the workpiece. Unfortunately, the data of the processing quality can not be really associated with the workpiece. Namely, quality of the processed workpiece and the relative information can not be tracked in the future. In the case of wheel rim, it is almost impossible to tell the model, outer diameter, PCD bore size, and other relative information of every processed wheel rim directly from its appearance. Therefore, if the information or data generated during the processing can be put on the workpiece in a digital pattern that can be identified with suitable devices for instantly showing relative information regarding the workpiece, it will be helpful for workpiece management and purchaser's understanding of the workpiece.

### SUMMARY OF THE PRESENT INVENTION

Therefore, an object of the present invention is to provide a digital marking processing apparatus that can digitally mark a workpiece.

Accordingly, the digital marking processing apparatus according to the present invention comprises a central control unit, and a processing quality prediction unit, a processing unit and a marking unit which are respectively connected with the central control unit electrically. The processing quality prediction unit can implement a virtual processing quality prediction method to predict the processing quality of the workpiece, output an accurate data of quality to the central control unit and generate tool path for the processing unit to process the workpiece. The central control unit is able to compile the data of quality from the processing quality prediction unit into file information, so that the marking unit can then utilize the file information to correspondingly mark barcode or other digital pattern on the workpiece, which facilitate workpiece management and information disclosure.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram illustrating a digital marking processing apparatus according to the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

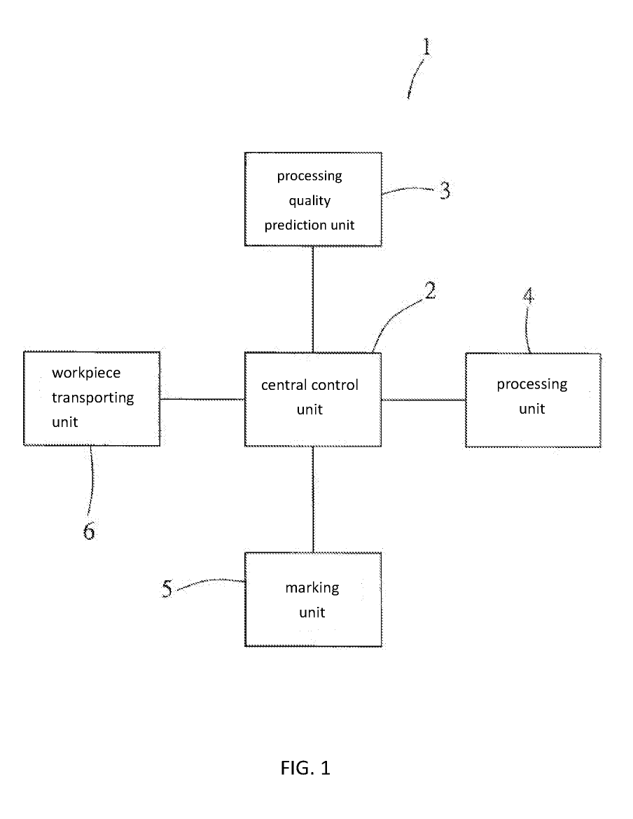

Referring to FIG. 1, the processing apparatus according to a preferred embodiment of the present invention is for processing a workpiece and forming digital label thereon. The processing apparatus 1 comprises a central control unit 2, and a processing quality prediction unit 3, a processing unit 4, a marking unit 5, and a workpiece transporting unit 6 which are connected with the central control unit 2 electrically.

The processing quality prediction unit 3 utilizes the technology disclosed in Taiwan Patent Number TWI481978B, entitled “Method for predicting machining quality of machine tool.” It mainly applies Computer-Aided Design (CAD) to produce the outline, dimensions, and tolerance of the workpiece and uses Computer Aided Manufacturing (CAM) to generate processing path based on the above dimensions and tolerance as well as the characteristics of the processing unit 3. Also, at least a product accuracy category has to be assigned. The product accuracy category comprises roughness and/or dimension deviation, and etc. The dimension deviation comprises straightness, angularity, perpendicularity, parallelism, and/or roundness, etc. The product accuracy category is associated with the processing path so as to provide a plurality of relevances between the product accuracy category and the processing path. Then, the processing unit 4 will be utilized to process multiple workpieces according to the processing path to produce workpiece samples and to collect multiple sets of sample detection information of the multiple workpiece samples that relate to the processing path during the processing period. After the operation of sampling, it utilizes algorithm to control the noise of the detection information and convert the detection information of workpiece sample into sample characteristic data in correspondence with characteristic format. After the processing of workpiece sample is finished, the metrology machine is utilized to measure the product accuracy category(ies) of the workpiece sample so as to obtain a set of quality sample data (value of accuracy). Then the quality sample data and the characteristic data of the workpiece sample are utilized to predict the interrelation between the algorithm and processing path and the product accuracy category, in order to build a prediction model for the product accuracy category. That is to say, the characteristic data, quality sample data, and accuracy of workpiece, which are obtained when the processing unit 4 processed the workpiece sample, are utilized to form a prediction model.

In short, the processing quality prediction unit 3 generates workpiece processing path for the target workpiece according to the predetermined dimensions, tolerance, and parameters and virtually predicts the processing quality of the workpiece and outputs accurate data of workpiece quality to the central control unit 2. The central control unit 2 can then compile the data of quality from the processing quality prediction unit 3 into file information. The marking unit 5 can be embodied as a laser marker or a pneumatic marker, which correspondingly mark barcode, QR code, or other digital pattern based on the file information on the workpiece. The digitalized content may flexibly contain, for example, manufacturing date, serial number, dimensional accuracy, surface roughness, website address, and etc. The workpiece transporting unit 6 is for transporting the workpiece to the processing unit 4 and the marking unit 5. The workpiece transporting unit 6 is embodied as a robot arm, which can also transmit the feature information of the workpiece being transported, such as that it is transporting the workpieces of the model of Area A, to the central control unit 2.

The digital marking processing apparatus 1 according to the present invention processes target workpieces as follows. The processing quality prediction unit 3 generates processing path based on the information of the design. The workpiece transporting unit 6 transports the workpiece to the processing unit 4 for processing. The workpiece transporting unit 6 immediately records the feature information of the workpiece being transported. After the workpiece is processed, the workpiece transporting unit 6 will transport it to the marking unit 5 for digital marking. In the present embodiment, the marking unit 5 is embodied as a laser marker which receives information related to the processing of the workpiece from the central control unit 2, converts the information into digital pattern, and marks the digital pattern on the workpiece.

The above mentioned digital pattern marked by the marking unit 5 is associated with all the processing quality, data, or other information regarding the workpiece. One can rapidly and fully understand the relative information regarding the workpiece by identifying the marked digital pattern with suitable digital reader or scanner. Hence, the digital marking processing apparatus 1 according to the present invention combines both the processing quality prediction unit 3 and the digital marking unit 5 to directly and rapidly mark processing quality or other relative information on the workpiece and help on workpiece management and workpiece information providing.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A digital marking processing apparatus for a workpiece, comprising:
a central control unit;
a processing quality prediction unit;
a processing unit; and
a marking unit, wherein said processing quality prediction, said processing unit and said marking unit are respectively connected with said central control unit electrically, wherein said processing quality prediction unit implements a virtual processing quality prediction method to predict a processing quality of the workpiece, output an accurate data of quality to said central control unit and generate a tool path for said processing unit to process the workpiece, wherein said central control unit is able to compile the data of quality from said processing quality prediction unit into a file information, so that said marking unit is able to then utilize said file information to correspondingly mark barcode or other digital pattern on the workpiece.

2. The digital marking processing apparatus, as recited in claim 1, further comprising a workpiece transporting unit connected with said central control unit electrically, wherein said workpiece transporting unit transports the workpiece to said processing unit for processing and sends an information of workpiece transportation to said central control unit.

3. The digital marking processing apparatus, as recited in claim 2, wherein said workpiece transporting unit is a robot arm.

4. The digital marking processing apparatus, as recited in claim 1, wherein said marking unit is a laser marker.

5. The digital marking processing apparatus, as recited in claim 1, wherein said marking unit is a pneumatic marker.
